(19) United States
(12) Patent Application Publication
(10) Pub. No.: US 2008/0003328 A1
(43) Pub. Date: Jan. 3, 2008

(54) Food Product Rich In Fat/Oil, Protein and Sweetening Agent

(75) Inventors: Ambrose Jacob Spinnler Benade, Western Cape (ZA); Christiaan De Wet Marais, Western Cape (ZA); Unnikrishnan Ramachandran Unnithan, Johor Darul Takzim (MY); Siew Pheng Foo, Johor Darul Takzim (MY)

Correspondence Address: BIRCH STEWART KOLASCH & BIRCH, PO BOX 747, FALLS CHURCH, VA, 22040-0747, US

(73) Assignees: South African Medical Research Council, West Cape (ZA); Carotino Sdn. Bhd., Johor Darul Takzim (MY); Carotino (Singapore) Pte. Ltd., Singapore (SG)

(21) Appl. No.: 10/590,733

(22) PCT Filed: Aug. 30, 2004
(86) PCT No.: PCT/SG04/00263

§ 371 Date: Dec. 20, 2006

(30) Foreign Application Priority Data
Feb. 25, 2004 (ZA) 2004/1530

(51) Int. Cl. A23L 1/24

(52) U.S. Cl. 426/72; 426/311

(57) ABSTRACT

A food product comprising fat and/or oil, high protein food source, sweetening agent and at least one type of vitamins, minerals and/or trace elements is disclosed herein. Preferably, the fat and/or oil contain high level of carotenoids, tocopherols and/or tocotrienols; the high protein food source is soy flour; the sweetening agent is sugar syrup having water content between 15 wt % to 25 wt %. Essential water-soluble micronutrients such as vitamin C, iron, zinc and selenium are successfully blended into the food product made possible by a mixing sequence/technique which is also disclosed herein.

### FIELD OF THE INVENTION

The present invention relates to a food product enriched with micronutrients, in particular a spreadable food product.

### BACKGROUND OF THE INVENTION

Populations in certain developing countries are known to suffer from specific vitamin and/or mineral (micronutrients) deficiencies, mainly because of a low dietary intake of these nutrients. These deficiencies are known to impact negatively on the health, growth and development of children. Increased susceptibility to infections as a result of these micronutrient deficiencies in school learners may also lead to lower school attendance rates, impaired mental ability and consequently compromised school performance. Addressing these deficiencies in school learners has proved to have beneficial effects on the nutritional status, health, school attendance and mental abilities of the learners. Although there are several strategies for addressing these deficiencies, the food-based approach is generally accepted as the most sustainable one.

Micronutrient deficiencies among school learners in certain developing countries are a cause of great concern. Although a school feeding scheme was introduced in South Africa, the main objective of the scheme was to provide about 25% of the energy requirements of the learners. No special attempt was made to address the micronutrient deficiencies which are known to exist in these learners. Several menus were formulated and one menu specifically prescribed bread and peanut butter as an option.

Bread and peanut butter have become a popular choice of many schools. There are, however, many disadvantages associated with this peanut butter and bread menu. In South Africa, peanut butter is often contaminated with aflatoxin, which poses serious health risks to the consumer. Also, where micronutrient deficiencies exist, peanut butter consumption has no impact on micronutrient deficiencies in learners.

The applicants have therefore identified a need for a safe food product that is relatively inexpensive to produce and that addresses the nutritional needs of children in particular, by providing not only a source of energy but also a safe source of micronutrients and vitamins.

### SUMMARY OF THE INVENTION

According to a first aspect of the invention, there is provided a food product having a composition including:
a high protein food source;
a fat, oil or mixture thereof; and
at least one micronutrient.

The food product may be a spreadable food product, for example, a paste.

The micronutrient may be substantially micro-encapsulated by the fat and/or oil in the food product.

The product may further include one or more vitamins, such as vitamins A, C, and/or E; a sweetening agent and/or energy source, such as sugar or sugar syrup; and a flavouring agent.

The high protein food source may be high-protein flour, such as soy flour.

The fat and/or oil may be rich in carotenoids, tocopherols and/or tocotrienols. For example, the fat and/or oil may be Carotino™ CS35FV.

The sugar syrup may be invert or partial invert syrup, and typically has a water content of between 15 wt % to 25 wt %. The sugar syrup is preferably Puratex 78150.

The source of Vitamin C may be ascorbic acid, sodium ascorbate or potassium ascorbate.

The micronutrients may include a source of iron, zinc or selenium, or a mixture thereof.

The source of iron may be one or more compounds selected from the group consisting of ferrous fumerate, ferrous gluconate, ferrous phosphate, ferrous sulphate, elemental iron or electrolytic iron, ferric pyrophosphate, ferric ammonium citrate, ferric orthophosphate, Na Fe EDTA, ferrous lactate, ferrous succinate and ferrous saccharate.

The source of zinc may be one or more compounds selected from the group consisting of zinc amino acid chelate, zinc gluconate, zinc oxide, zinc sulphate, zinc undecylenate, zinc chloride, zinc stearate and zinc acetate.

The source of selenium may be one or more compounds selected from the group consisting of selenium yeast, selenium sulfide, selenium amino acid chelate, selenium oxide, sodium selenite and sodium selenate.

The food product preferably includes the micronutrients ferrous fumerate, zinc amino acid chelate and selenium amino acid chelate.

The overall water content in the food product may be below 7 wt %. Preferably, the overall water content in the food product is about 6 wt %.

Typically, the composition of the food product includes:
a) 64.50±35 wt % of the fat and/or oil;
b) 15.48±15 wt % of the high protein food source;
c) 0.03-0.66 wt % of micronutrients;
d) 0.02-0.30 wt % of the vitamin;
e) 19.35±19 wt % of the sweetening agent and/or energy source; and
f) 0.10-0.30 wt % of the flavouring agent.

Typically, the micronutrients include 18.59 wt % of iron fumerate, 61.06 wt % of zinc amino acid chelate and 20.35 wt % of selenium amino acid chelate.

The content of the vitamin(s) is preferably 0.15 wt %, and the content of the flavouring agent(s) is preferably 0.19 wt %.

Preferably, 100 g of the food product composition includes:
a) 68.5 g±35% of the fat and/or oil;
b) 6.5 g±15% of the protein food source;
c) 17.6 g±19% of a carbohydrate;
d) 7-75 mg of a source of iron;
e) 6.9-70 mg of a source of zinc;
f) 26-266 μg of a source of selenium;
g) 15-300 mg of ascorbic acid;
h) 80-250 mg of a flavouring agent;
i) 32 mg±10% of carotenoids;
j) 32 mg±10% of tocopherols and/or tocotrienols;
k) 50 mg±10% of isoflavones, and
l) 6 g±10% of moisture.

According to a second aspect of the invention, there is provided a method of making a food product which includes the steps of:
a) mixing at least one micronutrient with a first portion of a high protein food source to form mixture (a);
b) adding a fat and/or oil to mixture (a) and mixing them together to form a combined mixture (b);
c) adding the combined mixture (b) to a second portion of a high protein food source to form the food product; and
d) optionally adding a sweetening agent, a vitamin and a flavouring agent to the food product.

The micronutrient, high protein food source, fat, oil, sweetening agent and/or energy source, and/or flavouring agent may be substantially as described above.

### DETAILED DESCRIPTION OF THE INVENTION

The invention describes a food product having a composition which includes a high protein food source, a fat or oil or a mixture thereof, and at least one micronutrient. Optionally, the food product also includes one or more essential water-soluble micronutrients, such as iron, zinc and selenium. The food product may further include one or more vitamins, such as vitamins A, C and/or E. The vitamins may also have the benefit of being antioxidants. Additionally, the food product may also include a sweetening agent and/or energy source, carbohydrates and/or isoflavones.

The formation of a fat-based food product which includes water-soluble ingredients is made possible by the mixing sequence and technique. The micronutrients are substantially micro-encapsulated by the fat or oil, which protects them against oxidation and interaction with the vitamin C, thereby rendering the product stable and resistant to rancidity and fungal growth.

The food product has low water content, and this, together with the blending sequence, results in a food product comprising a fat medium containing relatively high levels of antioxidants (tocopherols, tocotrienols, carotenoids and vitamin C) with micronutrients dispersed therein.

The high protein food source is generally high protein flour such as soy flour, but may be any other suitable high protein source.

The sweetening agent and/or energy source is generally a sugar in the form of a syrup, for example, an invert or partial invert syrup. Partial invert syrup is used in baking, confectionery, pharmaceutical and ice cream manufacturing. It is manufactured by a known process of acid inversion of refined sugar and followed by neutralisation of the sugar. The ratio of invert sugar to sucrose is about 2:1.

Generally, any sweetening agent or energy source with a water content of between 15 wt % and 25 wt % will be suitable.

Flavouring may also be added to the food product. The flavouring is any standard flavouring used in the food industry. It can be an oil, water or fat-soluble concentrate. Examples of flavours are banana, vanilla and chocolate.

The overall water content in the food product is generally below 7 wt %. For example, the food product in the example discussed herein has an overall water content of about 6.01%.

Apart from providing energy, the food product also provides a significant daily allowance of iron, zinc, selenium, vitamin C, vitamin A and vitamin E to those who ingest the product, in particular school learners, thus alleviating these deficiencies.

The following example will now be used to further illustrate the invention.

### EXAMPLE 1

Micronutrients used in the examples to illustrate the present invention are selected from sources of iron, zinc and selenium listed in Table 1.

TABLE 1

| Iron | Zinc | Selenium |
|---|---|---|
| Ferrous fumerate | Zinc amino acid | Selenium yeast |
| Ferrous gluconate | chelate | Selenium sulfide |
| Ferrous phosphate | Zinc gluconate | Selenium amino |
| Ferrous sulphate | Zinc oxide | acid chelate |
| Elemental iron/ | Zinc sulphate | Selenium oxide |
| electrolytic iron | Zinc undecylenate | Sodium selenite |
| Ferric pyrophosphate | Zinc chloride | Sodium selenate |
| Ferric ammonium citrate | Zinc stearate | |
| Ferric orthophosphate | Zinc acetate | |
| Na Fe EDTA | | |
| Ferrous lactate | | |
| Ferrous succinate | | |
| Ferrous saccharate | | |

The fat or oil used in the example is Carotino™ fat CS35FV, manufactured by Carotino Sdn Bhd of Malaysia. This fat or oil is rich in carotenoids, tocopherols or tocotrienols (vitamin E). Carotino™ fat CS35FV is manufactured from crude palm oil and refined according to a process described in U.S. Pat. No. 5,932,261, the disclosure of which is incorporated by reference herein.

Carotino™ fat CS35FV contains a wide spectrum of carotenoids, tocopherols and/or tocotrienols. Alpha-carotene and beta-carotene are the main carotenoids in Carotino™ fat CS35FV, constituting 91% of the total carotenoids. The carotene composition of Carotino™ fat CS35FV is shown in Table 2.

TABLE 2

| Carotene | Composition (%) | PPM |
|---|---|---|
| Phytoene | 2.0 | 10.0 |
| Phytofluene | 1.2 | 6.0 |
| Cis-beta-carotene | 0.8 | 4.0 |
| Beta-carotene | 47.4 | 237.0 |
| Alpha-carotene | 37.0 | 185.0 |
| Cis-alpha-carotene | 6.9 | 34.5 |
| Gamma-carotene | 1.3 | 6.5 |
| Zeta-carotene | 0.5 | 2.5 |
| Delta-carotene | 0.6 | 3.0 |
| Neurossporene | trace | — |
| Beta-Zeacarotene | 0.5 | 2.5 |
| Alpha-Zeacarotene | 0.3 | 1.5 |
| Lycopene | 1.5 | 7.5 |

| | |
|---|---|
| Total (ppm) | 500.0 |
| Typical range of total carotene content (ppm) | 250-700 |

Values provided by Carotino Sdn Bhd

The vitamin E composition of Carotino™ fat CS35FV is shown in Table 3.

TABLE 3

| Vitamin E | Composition (%) | PPM |
|---|---|---|
| Tocopherols | 20-30 | 80-240 |
| Tocotrienols | 70-80 | 280-640 |

| | |
|---|---|
| Total (ppm) | 360-880 |

Values provided by Carotino Sdn Bhd

The high protein food source in the food product is protein-rich soy flour. The soy flour used in the invention is cooked or roasted soy flour, preferably medium roast soy flour.

Puratex™ 78150, a product of Tongaat-Hulett Sugar Ltd, RSA, is a partial invert syrup which is used in the example. The standard specification of Puratex™ 78150 is provided in Table 4.

TABLE 4

| Specification | Unit | Measurement | |
|---|---|---|---|
| True dissolved solvents | % | 77.7-78.3 | |
| Dissolved solids | | 76.5-77.1 | |
| (Measured using refractometer) | | | |
| Level of invertion | % | 48.0-51.0 | |
| pH | | 4.5-5.5 | |
| Colour | IU | 120 | max |
| Ash (conductivity) | % | 0.1 | max |
| Sulphite as SO₂ | ppm | 70 | max |

The food product of the invention is made by using the following:
i) Carotino™ fat CS35FV,
ii) soy flour,
iii) Puratex™ 78150,
iv) micronutrient premix containing iron fumerate, zinc amino acid chelate and selenium amino acid chelate,
v) ascorbic acid, and
vi) any flavouring agent.

An example of the composition of the spreadable food product is shown in Table 5. This composition includes a micronutrient premix referred to in (iv) above. The ratio of iron fumerate, zinc amino acid chelate and selenium amino acid chelate is shown in Table 6.

TABLE 5

| | Composition | Range |
|---|---|---|
| Ingredient | (weight %) | (weight %) |
| Carotino ™ fat CS35FV^{a} | 64.50 | ±35 |
| Soy flour (medium roast)^{b} | 15.48 | ±15 |
| Puratex ™ 78150^{c} | 19.35 | ±19 |
| Micronutrient Premix | 0.33 | 0.03-0.66 |
| Ascorbic acid^{d} | 0.15 | 0.02-0.30 |
| Flavouring agent^{e} | 0.19 | 0.10-0.30 |

| | |
|---|---|
| Total | 100.00 |

^{a}Carotino Sdn Bhd, Malaysia
^{b}Pioneer Foods (Pty) Ltd, RSA
^{c}Tongaat-Hulett Sugar Ltd, RSA
^{d}Warren Chem Specialities, RSA
^{e}International Flavours and Fragrances (SA) (Pty) Ltd, RSA

TABLE 6

| | Composition | Range |
|---|---|---|
| Ingredient | (weight %) | (weight %) |
| Iron fumerate^{a} as a source of iron | 18.59 | 0-100 |
| Zinc amino acid chelate 10% (tasteless)^{b} | 61.06 | 0-100 |
| as a source of zinc | | |
| Selenium amino acid chelate 0.2%^{c} | 20.35 | 0-100 |
| as a source of selenium | | |

| | |
|---|---|
| Total | 100.00 |

^{a}BP 2001, USA 25 Warren Chem Specialities
^{b}Product ZNC 271, AMT Labs Inc, food grade
^{c}Product SEA 221, AMT Labs Inc

An example of a nutritional composition of the food product per 100 g is shown in Table 7.

TABLE 7

| | | |
|---|---|---|
| Nutrient | Weight | Range |

| | | | |
|---|---|---|---|
| Fat | 68.53 | g | ±35% |
| Protein | 6.51 | g | ±15% |
| Carbohydrate | 17.62 | g | ±19% |
| Iron | 21.08 | mg | 7.03-70.20 |
| Zinc* | 20.74 | mg | 6.90-69.06 |
| Selenium* | 133.00 | μg | 26.60-266.00 |
| Ascorbic acid | 150.00 | mg | 15-300 |
| Flavouring agent | 190.00 | mg | 180-250 |
| Total carotenoids | 32.26 | mg | ±10% |
| Total tocopherol | 32.26 | mg | ±10% |
| and/or tocotrienol | | | |
| Isoflavones | 50.00 | mg | ±10% |
| Moisture | 6.01 | g | ±10% |

*As amino acid chelate

An example of a nutritional composition of the food product per 15 g is shown in Table 8.

TABLE 8

| Nutrient | Weight | | Range | | % Rda |
|---|---|---|---|---|---|
| Fat | 10.28 | g | ±35% | | — |
| Protein | 0,.8 | g | ±15% | | — |
| Carbohydrate | 2.64 | g | ±19% | | — |
| Iron | 3.16 | mg | 1.05-10.5 | mg | 32 |
| Zinc | 3.11 | mg | 1.03-10.3 | mg | 31 |
| Selenium | 20.00 | μg | 4-40 | μg | 50 |
| Ascorbic acid | 22.50 | mg | 4.5-45 | mg | 50 |

| Beta-carotene | 2.29 | mg | ±10% | |
|---|---|---|---|---|
| Alpha-carotene | 1.79 | mg | ±10% | |
| Other carotenes | 0.76 | mg | ±10% | |
| Retinol equivalents | 300-1000 | | ±25% | 60-200* |
| (RE) | | | | |
| Alpha-tocopherol | 0.97 | mg | ±50% | 2.10 as |
| Tocotrienols | 3.87 | mg | ±15% | alpha- |
| | | | | tocopherol |
| | | | | equivalents |
| | | | | (alpha-TE) |
| Isoflavones | 7.50 | mg | ±10% | — |

Total energy per portion = 448 kJ ± 10%
*Depends on conversion factor used for beta-carotene i.e. 6 μg all-trans-beta-carotene = 1 μg of all-trans-retinol, or 2 μg all-trans-beta-carotene in oil = 1 μg of all-trans-retinol

A typical fatty acid composition in the food product is shown in Table 9.

TABLE 9

| Fatty Acid | Composition (%) |
|---|---|
| 14:0 | 1.25 |
| 16:0 | 40.03 |
| 16:1 | 0.16 |
| 18:0 | 4.83 |
| 18:1 | 38.32 |
| 18:2 | 14.07 |
| 18:3 | 0.73 |
| 20:0 | 0.31 |
| 20:1 | 0.13 |
| 22:0 | 0.09 |
| 24:0 | 0.11 |

One method of making the food product is described below.

Step One:

A micronutrient premix comprising iron fumarate, zinc amino acid chelate and selenium acid chelate as per Tables 5 and 6 was formed by mixing the ingredients until a homogenous mixture is obtained.

Step Two:

Carotino™ fat CS35FV, stored at ambient temperature, was stirred or fluffed until a smooth texture was obtained. This step simplifies the blending process of step four.

Step Three:

The micronutrient premix was mixed with approximately half of a measured amount of the soy flour, so that a uniform distribution of the micronutrient premix in the soy flour was obtained.

Step Four:

The mixture obtained from step three was added to the fat from step two and mixed together to form a combined mixture with a smooth texture. The remainder of the measured soy flour was then mixed into the combined mixture. This step not only results in uniform distribution of the micronutrients in the fat, but also results in substantial micro-encapsulation of the micronutrients. This micro-encapsulation protects the micronutrients from oxidation and interaction with Vitamin C, thereby prolonging the shelf life of the food product.

Step Five:

Puratex™ 78150 sugar syrup, ascorbic acid and flavouring agents were mixed together in one container until a uniform distribution was obtained. The ascorbic acid and flavouring agents are water soluble, and as the Puratex™ 78150 contains about 23% water it is therefore an ideal carrier for the ascorbic acid and flavouring agents. As the Puratex™ 78150 is the only source of water in the food product, the end product has low water content.

Step Six:

The mixture obtained from step five was mixed with the mixture obtained from step four until a smooth consistency was obtained.

Steps one to six were carried out at ambient room temperature.

The mixing sequence and technique prevents an interaction among the components in the food product, particularly the micronutrients. For example, the sequence of steps two to five results in a safe and stable product.

Tests were conducted for microbiological activity in the food product kept at room temperature. The results showed no significant change in microbiological activity after 4 months of shelf life at room temperature.

The food product may have the following properties and advantages:
i) It is safe for consumption on a daily basis.
ii) It has a relatively long shelf life of at least 4 months when kept at room temperature and is resistant to fungal growth.
iii) It contains high levels of natural antioxidants which reduce the need for synthetic preservatives.
iv) It has a low water content which reduces the need for emulsifiers.
v) It contains no hydrogenated fat (such as trans-fatty acids).
vi) It contains added iron, zinc, selenium, and/or vitamin C (such as ascorbic acid) to alleviate nutrient deficiencies, for example, in children.
vii) It is aflatoxin-free.

The food product may have the additional advantage of improving the general health, mental ability and school attendance in children who consume 15 g of the product per day. A further advantage is that the food product has a desirable texture, stability and colour that may appeal to consumers.

The examples given herein are not to be construed as limiting to the scope of the invention. For example, although ascorbic acid is described as the source of vitamin C, sodium ascorbate, potassium ascorbate and the like could also be used. Similarly, any other suitable minerals or micronutrients could be used, and the quantities of the various micronutrients, vitamins and flavouring agents can obviously be varied according to specific needs in a particular market.

1. A food product comprising
a) 64.50±35 wt % of fat and/or oil;
b) 15.48±15 wt % of high protein food source;
c) 0.03-0.66 wt % of micronutrient or a mixture of micronutrients;
d) 0.02-0.30 wt % of vitamin or a mixture of vitamins;
e) 19.35±19 wt % of sweetening agent; and
f) 0.10-0.30 wt % of flavouring or a mixture of flavourings.

2. A food product as claimed in claim 1 wherein the fat and/or oil is rich in carotenoids, tocopherols and/or tocotrienols.

3. A food product as claimed in claim 1 wherein the fat and/or oil is Carotino™ fat CS35FV or its equivalent.

4. A food product as claimed in claim 1 wherein the high protein food source is soy flour.

5. A food product as claimed in claim 1 wherein the high protein food source is medium roast soy flour.

6. A food product as claimed in claim 1 wherein the micronutrient or mixture of micronutrients is any minerals and/or trace elements.

7. A food product as claimed in claim 1 wherein the micronutrient or mixture of micronutrients is a blend of iron source, zinc source and selenium source.

8. A food product as claimed in claim 1 wherein micronutrient or mixture of micronutrients is a blend of iron fumerate, zinc amino acid chelate and selenium amino acid chelate.

9. A food product as claimed in claim 1 wherein the vitamin or mixture of vitamins is a vitamin C source.

10. A food product as claimed in claim 1 wherein the vitamin or mixture of vitamins is ascorbic acid, sodium ascorbate, potassium ascorbate or a blend thereof.

11. A food product as claimed in claim 1 wherein the sweetening agent is sugar syrup.

12. A food product as claimed in claim 1 wherein the sweetening agent is a sugar syrup having water content between 15 wt % to 25 wt %.

13. A food product as claimed in claim 1 wherein the sweetening agent is invert or partial invert syrup.

14. A food product as claimed in claim 1 wherein the sweetening agent is Puratex™ 78150 or its equivalent.

15. A food product as claimed in claim 1 wherein its overall water content is not more than 7 wt %.

16. A food product comprising
a) 64.50±35 wt % of fat and/or oil rich in carotenoids, tocopherols and/or tocotrienol;
b) 15.48±15 wt % of high protein food source;
c) 0.03-0.66 wt % of micronutrient or a mixture of micronutrients;
d) 0.02-0.30 wt % of vitamin or a mixture of vitamins;
e) 19.35±19 wt % of sugar syrup having water content between 15 wt % to 25 wt %; and
f) 0.10-0.30 wt % of flavouring or a mixture of flavourings.

17. A food product comprising
a) 64.50±35 wt % of Carotino™ fat CS35FV or its equivalent;
b) 15.48±15 wt % of soy flour;
c) 0.03-0.66 wt % of a blend of iron source, zinc source and selenium source;
d) 0.02-0.30 wt % of a vitamin C source;
e) 19.35±19 wt % of Puratex™ 78150 or its equivalent; and
f) 0.10-0.30 wt % of flavouring or a mixture of flavourings.

18. A food product as claimed in claim 7 or 17 wherein the iron source is one or more compound selected from a group comprising
ferrous fumerate,
ferrous gluconate,
ferrous phosphate,
ferrous sulphate,
elemental iron/electrolytic iron,
ferric pyrophosphate,
ferric ammonium citrate,
ferric orthophosphate,
Na Fe EDTA,
ferrous lactate,
ferrous succinate and
ferrous saccharate.

19. A food product as claimed in claim 7 or 17 wherein the zinc source is one or more compound selected from a group comprising
zinc amino acid chelate,
zinc gluconate,
zinc oxide,
zinc sulphate,
zinc undecylenate,
zinc chloride,
zinc stearate and
zinc acetate.

20. A food product as claimed in claim 7 or 17 wherein the selenium source is one or more compound selected from a group comprising
selenium yeast,
selenium sulphide,
selenium amino acid chelate,
selenium oxide,
sodium selenite and
sodium selenate.

21. A method of producing a food product comprising a fat and/or oil, a high protein food source and at least one micronutrient wherein the method includes the steps of
a) mixing at least one micronutrient with a first portion of high protein food source to form mixture (a);
b) fluffing a fat and/or oil before adding it to mixture (a) and mixing them to form a combined mixture (b);
c) mixing the combined mixture (b) with a second portion of high protein food source to form the food product; optionally
d) adding a sweetening agent, a vitamin or mixture of vitamins and/or a flavouring or mixture of flavourings to the food product.

22. A method of producing a food product as claimed in claim 21 wherein the fat and/or oil is rich in carotenoids, tocopherols and/or tocotrienols.

23. A method of producing a food product as claimed in claim 21 wherein the high protein food source is soy flour.

24. A method of producing a food product as claimed in claim 21 wherein the micronutrient is any minerals and/or trace elements.

25. A method of producing a food product comprising a fat and/or oil, a high protein food source and at least one micronutrient wherein the method includes the steps of
a) mixing at least one micronutrient with a first portion of soy flour to form mixture (a);
b) fluffing Carotino™ fat CS35FV or its equivalent before adding it to mixture (a) and mixing them to form mixture (b);
c) mixing mixture (b) with a second portion of soy flour to form mixture (c);
d) adding a blend of sugar syrup, vitamin C source and a flavouring or mixture of flavourings to mixture (c) and mixing them to form the food product.

26. A method of producing a food product as claimed in claim 25 wherein the micronutrient is a blend of iron source, zinc source and selenium source.

27. A method of producing a food product as claimed in claim 25 wherein the sugar syrup has water content between 15 wt % to 25 wt %.

28. A method of producing a food product as claimed in claim 25 wherein the sugar syrup is Puratex™ 78150 or its equivalent.

29. A method of producing a food product comprising a fat and/or oil, a high protein food source and at least one micronutrient wherein the method includes the steps of
a) mixing 0.03-0.60 wt % of at least one micronutrient with approximately half the required amount of high protein food source, in which the required amount of high protein food source is 0.5-30.5 wt %, to form mixture (a);
b) fluffing 29.5-99.5 wt % of fat and/or oil before adding it to mixture (a) and mixing them to form mixture (b);
c) mixing mixture (b) with balance of the required amount of high protein food source to form mixture (c);
d) adding a blend of 0.35-38.35 wt % of sweetening agent, 0.02-0.30 wt % of vitamin or a mixture of vitamins and 0.1-0.3 wt % of flavouring or a mixture of flavourings to mixture (c) and mixing them to form the food product.

30. A method of producing a food product as claimed in claim 29 wherein the fat and/or oil is rich in carotenoids, tocopherols and/or tocotrienols.

31. A method of producing a food product as claimed in claim 29 wherein the high protein food source is soy flour.

32. A method of producing a food product as claimed in claim 29 wherein the micronutrient is any minerals and/or trace elements.

33. A method of producing a food product as claimed in claim 29 wherein the sweetening agent is a sugar syrup having water content between 15 wt % to 25 wt %.

34. A method of producing a food product as claimed in claim 29 wherein the vitamin or mixture of vitamins is a vitamin C source.

35. A method of producing a food product comprising a fat and/or oil, a high protein food source and at least one micronutrient wherein the method includes the steps of
a) mixing 0.03-0.60 wt % of a blend of iron source, zinc source and selenium source with approximately half the required amount of soy flour, in which the required amount of soy flour is 0.5-30.5 wt %, to form mixture (a);
b) fluffing 29.5-99.5 wt % of Carotino™ fat CS35FV or its equivalent before adding it to mixture (a) and mixing them to form mixture (b);
c) mixing mixture (b) with balance of the required amount of soy flour to form mixture (c);
d) adding a blend of 0.35-38.35 wt % of Puratex™ 78150 or its equivalent, 0.02-0.30 wt % of vitamin C source and 0.1-0.3 wt % of flavouring or a mixture of flavourings to mixture (c) and mixing them to form the food product.

36. A method of producing a food product as claimed in claim 26 or 35 wherein the blend of iron source, zinc source and selenium source is comprised of iron fumerate, zinc amino acid chelate and selenium amino acid chelate.

37. A method of producing a food product as claimed in claim 26 or 35 wherein the iron source is one or more compound selected from a group comprising
ferrous fumerate,
ferrous gluconate,
ferrous phosphate,
ferrous sulphate,
elemental iron/electrolytic iron,
ferric pyrophosphate,
ferric ammonium citrate,
ferric orthophosphate,
Na Fe EDTA,
ferrous lactate,
ferrous succinate and
ferrous saccharate.

38. A method of producing a food product as claimed in claim 26 or 35 wherein the zinc source is one or more compound selected from a group comprising
zinc amino acid chelate,
zinc gluconate,
zinc oxide,
zinc sulphate,
zinc undecylenate,
zinc chloride,
zinc stearate and
zinc acetate.

39. A method of producing a food product as claimed in claim 26 or 35 wherein the selenium source is one or more compound selected from a group comprising
selenium yeast,
selenium sulphide,
selenium amino acid chelate,
selenium oxide,
sodium selenite and
sodium selenate.

40. A method of producing a food product as claimed in claim 25, 34 or 35 wherein the vitamin C source is ascorbic acid, sodium ascorbate, potassium ascorbate or a blend thereof.

41. A food product comprising a fat and/or oil, a high protein food source and at least one micronutrient characterized in that 100 gram of the food product comprises
a) 68.5 g±35% of fat;
b) 6.5 g±15% of protein;
c) 17.6 g±19% of carbohydrate;
d) 7-75 mg of iron;
e) 6.9-69 mg of zinc;
f) 26-266 μg of selenium;
g) 15-300 mg of ascorbic acid;
h) 80-250 mg of flavouring;
i) 32 mg±10% of carotenoids;
j) 32 mg±10% of tocopherols and/or tocotrienols;
k) 50 mg±10% of isoflavones, and
l) 6 g±10% of moisture.

42. A food product comprising a blend of
a) fat and/or oil rich in carotenoids, tocopherols and/or tocotrienols;
b) soy flour;
c) sugar syrup having water content between 15 wt % to 25 wt %
d) at least one type of vitamins, minerals and/or trace elements;
characterized in that the minerals and/or trace elements are substantially micro-encapsulated by the fat and/or oil.

43. A food product as claimed in claim 42 wherein its overall water content is not more than 7 wt %.

44. A food product as claimed in claim 42 wherein the fat and/or oil is Carotino™ fat CS35FV or its equivalent.

45. A food product produced by a method as claimed in any of claims 21 to 39.

46. A food product as claim in any of claims 1 to 20 and 42 to 45 wherein the food product is spreadable.
